(19) United States
(12) Patent Application Publication
(10) Pub. No.: US 2026/0186152 A1
(43) Pub. Date: Jul. 2, 2026

(54) DATA SHAPING APPARATUS, EVENT DETECTION SYSTEM, DATA SHAPING METHOD AND NON-TRANSITORY COMPUTER-READABLE MEDIUM

(71) Applicant: NEC Corporation, Minato-ku, Tokyo (JP)

(72) Inventors: Koji NEMOTO, Tokyo (JP); Yoshihiro MISHIMA, Tokyo (JP)

(73) Assignee: NEC Corporation, Minato-ku, Tokyo (JP)

(21) Appl. No.: 18/728,503

(22) PCT Filed: Mar. 28, 2022
(86) PCT No.: PCT/JP2022/015003

§ 371 Date: Jul. 12, 2024

(51) Int. Cl. G01S 19/41

(52) U.S. Cl. CPC G01S 19/41

(57) ABSTRACT

A data shaping apparatus includes: an abnormality detection unit configured to detect, as abnormal data, positioning data indicating an abnormal position from a positioning data group based on a movement constraint condition for a moving object, the positioning data group being a collection of positioning data at least indicating a position and a positioning time of the moving object; a first generation unit configured to generate first data from the positioning data group by replacing a position indicated by the abnormal data with a position assumed under a predetermined movement condition; and an output unit configured to output information based on the first data.

### TECHNICAL FIELD

The present disclosure relates to a data shaping apparatus, an event detection system, a data shaping method, and a non-transitory computer-readable medium.

### BACKGROUND ART

It is known that GPS data contain measurement errors due to the nature of estimating a position of an own vehicle by communicating with GPS satellites. For example, Patent Literature 1 discloses a method of interpolating GPS positioning results by using a time difference between a GPS positioning result at the time of generation of a GPS signal and a detection time of a detection result that should be synchronized with the generation time of the GPS signal. The above method improves synchronization accuracy by taking into account measurement errors caused by transfer delays of GPS measurement results.

### CITATION LIST

### Patent Literature

Patent Literature 1: Japanese Unexamined Patent Application Publication No. 2009-222438

### SUMMARY OF INVENTION

### Technical Problem

However, it is also known that GPS data further contain data missing (shortage of data) and/or other data abnormality, and the method disclosed in Patent Literature 1 described above cannot deal with (or address) such abnormalities.

In view of the problem described above, an object of the present disclosure is to provide a data shaping apparatus, an event detection system, a data shaping method, and a non-transitory computer-readable medium that improve the accuracy of estimation of a position based on positioning data represented by GPS data.

### Solution to Problem

A data shaping apparatus according to one aspect of the present disclosure includes: abnormality detection means for detecting, as abnormal data, positioning data indicating an abnormal position from a positioning data group based on a movement constraint condition for a moving object, the positioning data group being a collection of positioning data at least indicating a position and a positioning time of the moving object; first generation means for generating first data from the positioning data group by replacing a position indicated by the abnormal data with a position assumed under a predetermined movement condition; and output means for outputting information based on the first data.

An event detection system according to one aspect of the present disclosure includes a data shaping apparatus including: abnormality detection means for detecting, as abnormal data, positioning data indicating an abnormal position from a positioning data group based on a movement constraint condition for a moving object, the positioning data group being a collection of positioning data at least indicating a position and a positioning time of the moving object; first generation means for generating first data from the positioning data group by replacing a position indicated by the abnormal data with a position assumed under a predetermined movement condition; and output means for outputting information based on the first data. In addition, the event detection system also includes an image analysis apparatus configured to detect an event related to a vehicle on a basis of the information based on the first data and an image analysis result.

A data shaping method according to one aspect of the present disclosure includes: detecting, as abnormal data, positioning data indicating an abnormal position from a positioning data group based on a movement constraint condition for a moving object, the positioning data group being a collection of positioning data at least indicating a position and a positioning time of the moving object; generating first data from the positioning data group by replacing a position indicated by the abnormal data with a position assumed under a predetermined movement condition; and outputting information based on the first data.

A non-transitory computer-readable medium according to an aspect of the present disclosure stores a program causing a computer to execute: an abnormality detection process of detecting, as abnormal data, positioning data indicating an abnormal position from a positioning data group based on a movement constraint condition for a moving object, the positioning data group being a collection of positioning data at least indicating a position and a positioning time of the moving object; a first generation process of generating first data from the positioning data group by replacing a position indicated by the abnormal data with a position assumed under a predetermined movement condition; and an output process of outputting information based on the first data.

### Advantageous Effects of Invention

According to the present disclosure, it is possible to provide a data shaping apparatus, an event detection system, a data shaping method, and a non-transitory computer-readable medium that improve the accuracy of estimation of a position based on positioning data.

### BRIEF DESCRIPTION OF DRAWINGS

FIG. 1 is a block diagram illustrating a configuration of a data shaping apparatus according to a first example embodiment.

FIG. 2 is a view illustrating an overview of an event detection method according to a second example embodiment.

FIG. 3 is a block diagram illustrating an overall configuration of a system according to the second example embodiment.

FIG. 4 is a block diagram illustrating a configuration of a data shaping apparatus according to the second example embodiment.

FIG. 5 is a view for explaining abnormal data detection processing according to the second example embodiment.

FIG. 6 is a view for explaining first data generation processing according to the second example embodiment.

FIG. 7 is a view for explaining second data generation processing according to the second example embodiment.

FIG. 8 is a view for explaining third data generation processing according to the second example embodiment.

FIG. 9 is a conceptual diagram of smoothing by a Kalman filter according to the second example embodiment.

FIG. 10 is a view for explaining fourth data generation processing according to the second example embodiment.

FIG. 11 is a flowchart illustrating an example of a flow of a data shaping method according to the second example embodiment.

### EXAMPLE EMBODIMENT

Hereinafter, example embodiments of the present disclosure will be described in detail with reference to the drawings. In the drawings, the same or corresponding elements are denoted by the same reference numerals, and redundant description is omitted as necessary for clear description.

### <Preliminary Study by the Inventors>

In recent years, unsafe driving has been detected while estimating a position of an own vehicle by comparing analysis results of video data from a dashboard camera (driving recorder) or any other device with GPS (Global Positioning System) data.

Generally, video data are aggregated data of image data groups, and video analysis is often performed on an image-by-image basis. Further, the image data are captured at approximately constant intervals, and most driving recorders captures image data at 30 fps or 60 fps.

On the other hand, GPS data have problems such as irregular cycle sampling, data missing (shortage of data or data unavailability), and measurement errors due to the nature of estimating a position of an own vehicle by communicating with GPS satellites. Therefore, if GPS data simply match image analysis results, this causes inconvenience. In addition, the seriousness of these problems depends upon the performance of a GPS receiver, and it is difficult to address these problems in a unified manner.

For the reasons above, there is a need to shape GPS data to match video data. Here, as one of methods of shaping GPS data, a method of correcting a position by using map data can be cited. However, since this method requires the preparation of map data, a method of correcting a position more simply is needed.

The following example embodiments have been made to solve at least one of such problems.

### First Example Embodiment

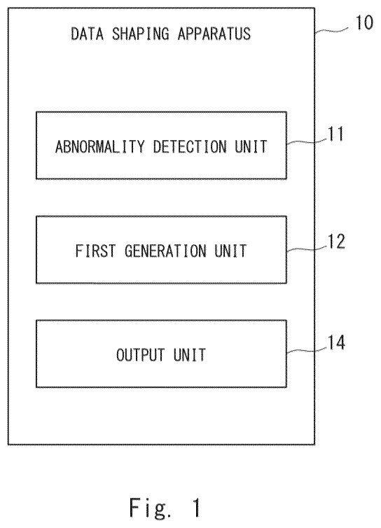

Next, a first example embodiment of the present disclosure will be described. FIG. 1 is a block diagram illustrating a configuration of a data shaping apparatus 10 according to the first example embodiment. The data shaping apparatus 10 is an apparatus composed of one or more computers, which shapes a positioning data group that is a collection of positioning data obtained by measuring a position of a moving object. For example, positioning data are data obtained by measuring a position based on reception results from satellites. As an example, positioning data are GPS data obtained by measuring a position based on reception results from GPS satellites, but they may be data using satellites of another satellite positioning system. The positioning data are data that at least indicate a position and a positioning time of a moving object. Specifically, the positioning data contains information on the longitude and latitude of the moving object and information on a time.

The data shaping apparatus 10 includes an abnormality detection unit 11, a first generation unit 12, and an output unit 14.

The abnormality detection unit 11 is also referred to as abnormality detection means. The abnormality detection unit 11 detects, as abnormal data, positioning data containing an abnormal position from a positioning data group based on a movement constraint condition that indicates a movement constraint for the moving object.

The movement constraint condition is at least one of a position constraint condition indicating a constraint condition regarding a position of the moving object, a speed constraint condition indicating a speed condition regarding a speed of the moving object, or an acceleration constraint condition indicating a constraint condition regarding an acceleration of the moving object.

For example, in a case where there is a positioning time that does not satisfy a position constraint condition at a position of the moving object indicated by the positioning data group, the abnormality detection unit 11 detects, as abnormal data, the positioning data corresponding to the positioning time. As an example, the abnormality detection unit 11 detects, abnormal data, positioning data in which a difference in position between positioning data measured at adjacent times is equal to or greater than a predetermined threshold value.

Further, for example, the abnormality detection unit 11 calculates a speed of the moving object at each positioning time based on the positioning data group. Then, in a case where there is a positioning time at which the speed does not satisfy the speed constraint condition, the abnormality detection unit 11 detects, as abnormal data, the positioning data corresponding to the positioning time. As an example, the abnormality detection unit 11 detects, as abnormal data, positioning data in which a difference in speed between positioning data measured at adjacent times is equal to or greater than a predetermined threshold value.

Further, for example, the abnormality detection unit 11 calculates an acceleration of the moving object at each positioning time based on the positioning data group. Then, in a case where there is a positioning time at which the acceleration does not satisfy the acceleration constraint condition, the abnormality detection unit 11 detects, as abnormal data, the positioning data corresponding to the positioning time. As an example, the abnormality detection unit 11 detects, as abnormal data, positioning data in which the acceleration exceeds the travel limit of the moving object.

The first generation unit 12 is also referred to as first generation means. The first generation unit 12 generates first data from the positioning data group by replacing a position indicated by the abnormal data with a position assumed under a predetermined movement condition. The predetermined movement condition may be, for example, uniform speed motion or uniform acceleration motion.

The output unit 14 is also referred to as output means. The output unit 14 outputs information based on the first data. The information based on the first data may be the first data themselves, or may be information that is generated based on the first data. The term “output information” may mean that “information is transmitted to an external device”, or may mean that “information is transmitted to an external device and the external device is caused to display the information or output the information as sound.

Thus, according to the first example embodiment, the data shaping apparatus 10 detects abnormalities of the positioning data based on the movement constraint condition, and corrects them in accordance with the predetermined movement condition. Therefore, in a case where data missing (or data loss) occurs in the positioning data group, it is possible to interpolate data appropriately. In addition, in a case where the positioning data group contains a sudden abnormal value, it is possible to correct the data appropriately. This makes it possible to improve the accuracy of estimation of the position based on the positioning data suitably.

### Second Example Embodiment

Next, a second example embodiment of the present disclosure will be described. The second example embodiment is a concrete example of the first example embodiment. In the second example embodiment, an event related to a moving object is detected by using data shaping in combination with image analysis. In the second example embodiment, the moving object is a vehicle as an example. Events to be detected therein are event related to unsafe driving, and there are traffic light ignoring, stop sign ignoring, or overspeed for the vehicle as examples.

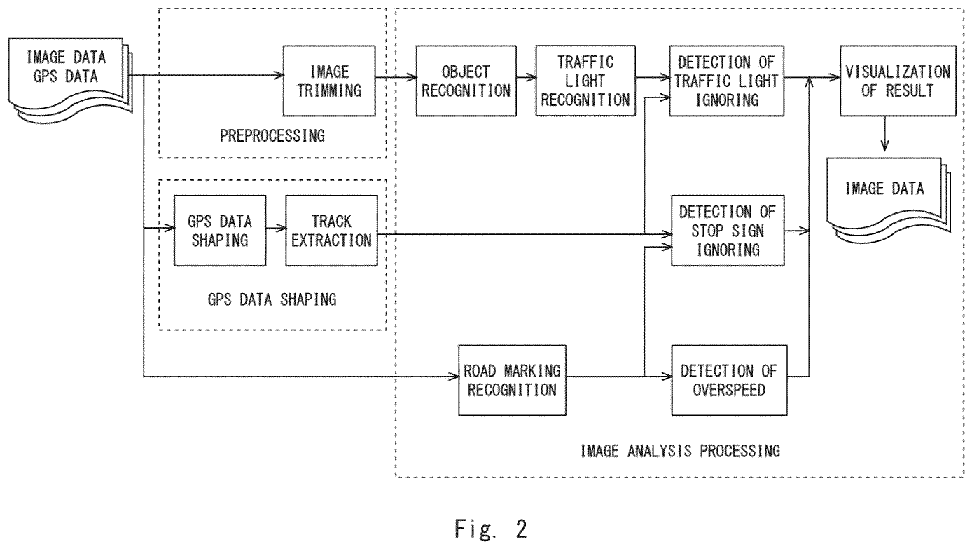

FIG. 2 is a view illustrating an overview of an event detection method according to the second example embodiment. Event detection is performed by an event detection system. The event detection can roughly be divided into a preprocessing stage, data shaping, and an image analysis processing stage. Image data photographed by an in-vehicle camera and GPS data generated based on reception results of a GPS receiver mounted on a vehicle become input data.

For example, in case of detecting traffic light ignoring, the event detection system trims inputted image data at the preprocessing stage, and performs object recognition or traffic light recognition at the image analysis processing stage. On the other hand, the event detection system shapes inputted GPS data into normal data, and extracts a track. Extraction of the track includes determination of whether the vehicle is going straight, turning right, or turning left based on the track. Then, the event detection system detects traffic light ignoring based on a traffic light recognition result from the image data, the shaped GPS data at the same point of time, and a determination result such as going straight.

Further, for example, in case of detecting stop sign ignoring, the event detection system recognizes road marking in the inputted image data at the image analysis processing stage. Then, the event detection system detects stop sign ignoring based on a recognition result of a stop sign, the shaped GPS data at the same point of time, and a determination result such as going straight.

Further, for example, in case of detecting overspeed, the event detection system recognizes road marking in the inputted image data at the image analysis processing stage. Then, the event detection system detects overspeed by comparing CAN (Controller Area Network) data at the same point of time of the image data with a recognition result of a speed sign. Alternatively, the event detection system may calculate a speed from the shaped GPS data at the same point of time, and detect overspeed by comparing the calculated speed with the recognition result of the speed sign.

When various kinds of events are detected, the event detection system generates image data obtained by visualizing a detection result, and outputs them. The image data to be outputted may be a still image or a video.

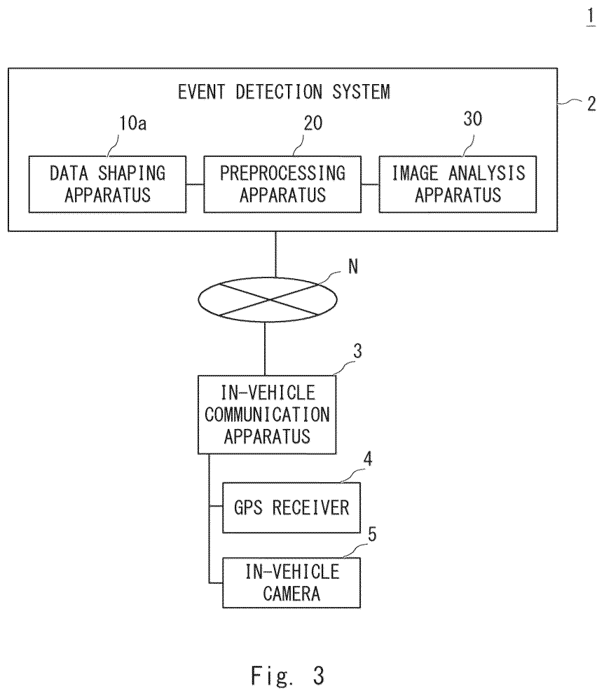

FIG. 3 is a block diagram illustrating an overall configuration of a system 1 according to the second example embodiment. The system 1 includes an in-vehicle communication apparatus 3 and an event detection system 2. The in-vehicle communication apparatus 3 and the event detection system 2 are connected to a network N. The network N is a communication network such as the Internet. Note that the system 1 may include a plurality of in-vehicle communication apparatuses 3.

The in-vehicle communication apparatus 3 is a communication apparatus mounted on a vehicle. The in-vehicle communication apparatus 3 may be an in-vehicle navigation device, a dedicated communication device, or a smartphone or tablet terminal used by a passenger of the vehicle.

The in-vehicle communication apparatus 3 is connected to a GPS receiver 4. The GPS receiver 4 is a receiver that receives radio waves from a plurality of GPS satellites. The in-vehicle communication apparatus 3 determines a position of the own vehicle based on reception results of the radio waves from the plurality of GPS satellites by the GPS receiver 4, and generates GPS data containing position information and a positioning time. For example, the in-vehicle communication apparatus 3 generates GPS data at a sampling period of once per second (that is, 1 fps). Then, the in-vehicle communication apparatus 3 transmits the GPS data to the event detection system 2 via the network N.

The in-vehicle communication apparatus 3 is also connected to an in-vehicle camera 5. The in-vehicle camera 5 is a camera mounted on the vehicle and configured to photograph the scenery outside the vehicle. For example, the in-vehicle camera 5 generates image data at 10 frames per second (10 fps), and supplies them to the in-vehicle communication apparatus 3. The in-vehicle communication apparatus 3 transmits the image data to the event detection system 2 via the network N. Note that in this figure, the GPS receiver 4 and the in-vehicle camera 5 are illustrated so as to be installed independently of the in-vehicle communication apparatus 3, but at least one of the GPS receiver 4 or the in-vehicle camera 5 may be configured as an integral part of the in-vehicle communication apparatus 3.

The event detection system 2 includes a data shaping apparatus 10a, a preprocessing apparatus 20, and an image analysis apparatus 30.

The data shaping apparatus 10a is an apparatus that shapes the GPS data received from the in-vehicle communication apparatus 3. The data shaping apparatus 10a shapes the GPS data so as to have the same sampling period as that of the image data. Then, the data shaping apparatus 10a performs determination of whether to go straight or not and the like based on the shaped GPS data.

The preprocessing apparatus 20 is an apparatus that performs various preprocessing. For example, the preprocessing apparatus 20 trims the image data received from the in-vehicle communication apparatus 3.

The image analysis apparatus 30 is an apparatus that performs image analysis at the image analysis processing stage described above based on the image data preprocessed by the preprocessing apparatus 20. Then, the image analysis apparatus 30 detects an event based on an image analysis result, the GPS data at the same time shaped by the data shaping apparatus 10a, and a determination result such as going straight. Moreover, the image analysis apparatus 30 generates image data obtained by visualizing a detection result. The image data generated by the image analysis apparatus 3 and the detection result can be used in a variety of applications, such as driving monitoring and safe driving support.

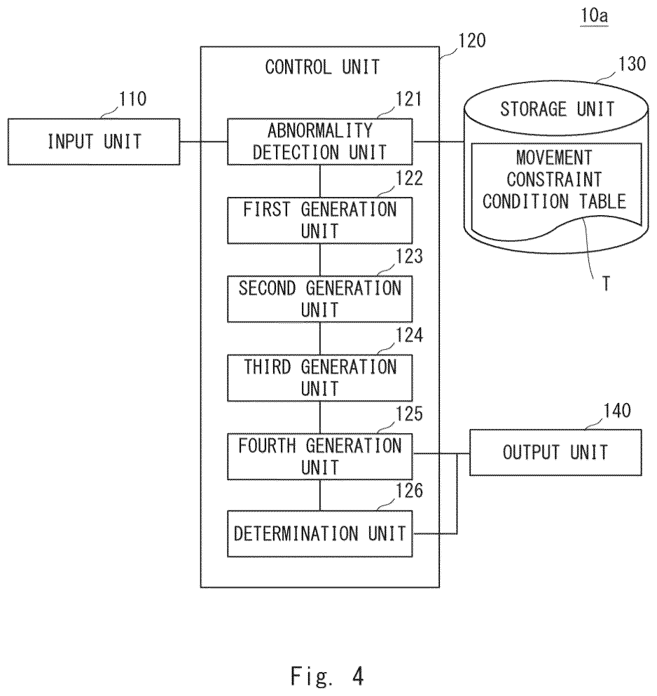

FIG. 4 is a block diagram illustrating a configuration of the data shaping apparatus 10a according to the second example embodiment. The data shaping apparatus 10a includes an input unit 110, a control unit 120, a storage unit 130, and an output unit 140.

The input unit 110 accepts (or receives) an input of a GPS data group obtained by measuring positions during a predetermined period and received from the same in-vehicle communication apparatus 3. Note that in the following, each of the inputted GPS data may also be referred to as a positioning point.

The storage unit 130 is a storage device that stores information required for processes of the data shaping apparatus 10a. The storage unit 130 mainly stores a movement constraint condition table T. The movement constraint condition table T is a table in which movement constraint conditions for a vehicle are defined.

The movement constraint condition is a condition related to constraints imposed on the movement of a moving object due to the physical characteristics of the moving body, a status of a route, and the like. For example, the movement constraint condition is at least one of a position constraint condition, a speed constraint condition, or an acceleration constraint condition.

For example, the position constraint condition may be that positions of adjacent positioning points are not too far apart, that is, a difference between a position of a positioning point to be determined (which is also referred to as a target positioning point) and a position of a positioning point whose positioning time is adjacent to that of the target positioning point (which is also referred to as adjacent positioning point) is within a predetermined value. In addition, for example, the position constraint condition may be that data missing does not occur. Data may be internally interpolated with a previous value at the time of data loss (or data missing). Thus, the absence of data loss may mean that the position of the target positioning point does not match the position of the adjacent positioning point. In addition, for example, the position constraint condition may be that the position is along a travel route defined in advance, that is, the position of the target positioning point is within a predetermined distance from the travel route defined in advance. For example, a bus travel route defined in advance may be used as a reference travel route.

For example, the speed constraint condition may be that a vehicle does not accelerate or decelerate to the extent that the vehicle cannot achieve, that is, a difference between a speed of the vehicle at a target positioning point and a speed of the vehicle at the adjacent positioning point is within a predetermined value. In addition, for example, the speed constraint condition may be that the speed of the vehicle at the target positioning point is a speed that does not exceed the travel limit of the vehicle. In addition, for example, the speed constraint condition may be that a speed based on GPS data and a speed measured by another measurement equipment are not too far apart. As an example, the speed constraint condition may be that an error between the speed based on the GPS data and a speed based on CAN data of the vehicle is less than or equal to a predetermined value.

For example, the acceleration constraint condition may be that an acceleration of a vehicle at a target positioning point is an acceleration that does not exceed the travel limit of the vehicle. In addition, for example, the acceleration constraint condition may be that an acceleration based on GPS data and an acceleration measured by another measurement equipment are not too far apart. As an example, the acceleration constraint condition may be that an error between the acceleration based on the GPS data and an acceleration based on CAN data of the vehicle is less than or equal to a predetermined value.

The control unit 120 is configured to control hardware included in the data shaping apparatus 10a. The control unit 120 includes an abnormality detection unit 121, a first generation unit 122, a second generation unit 123, a third generation unit 124, a fourth generation unit 125, and a determination unit 126.

The abnormality detection unit 121 is an example of the abnormality detection unit 11 according to the first example embodiment. The abnormality detection unit 121 detects abnormal data from the GPS data group received by the input unit 110 based on the movement constraint conditions defined in the movement constraint condition table T. Specifically, the abnormality detection unit 121 determines whether each of the GPS data satisfies the movement constraint condition or not, and detects, as abnormal data, GPS data that do not satisfy the movement constraint condition.

The first generation unit 122 is an example of the first generation unit 12 according to the first example embodiment. The first generation unit 122 replaces a position indicated by the abnormal data in the GPS data group with a position obtained by assuming uniform motion or uniform acceleration motion. Thus, the first generation unit 122 generates first data.

The second generation unit 123 is also referred to as second generation means. Here, the GPS data appears to be measured at regular intervals. However, since an actual positioning time depends upon the timing of reception from each of the GPS satellites, the GPS data are strictly sampled at irregular cycles. Therefore, the second generation unit 123 resamples the first data obtained by correcting the GPS data at a substantially fixed cycle, and generates second data.

The third generation unit 124 is also referred to as third generation means. Since the second data contain a measurement error, that is, positional deviation, the third generation unit 124 smooths the second data with a state estimation filter. A Kalman filter can be cited as the state estimation filter. Thus, the third generation unit 124 generates third data obtained by correcting the positional deviation.

The fourth generation unit 125 is also referred to as fourth generation means. The fourth generation unit 125 samples the third data again at the same cycle (for example, 10 fps) as a frame rate of the image data in order to match the frame rate of the image data. Thus, the fourth generation unit 125 generates fourth data that can be matched with information based on the image data.

The determination unit 126 determines whether a moving object is going straight, turning right, or turning left based on the fourth data.

The output unit 140 outputs the generated fourth data to the image analysis apparatus 30. In addition, the output unit 140 outputs a determination result by the determination unit 126 to the image analysis apparatus 30. Note that an output destination of the fourth data or the determination result may be the preprocessing apparatus 20 depending upon the application.

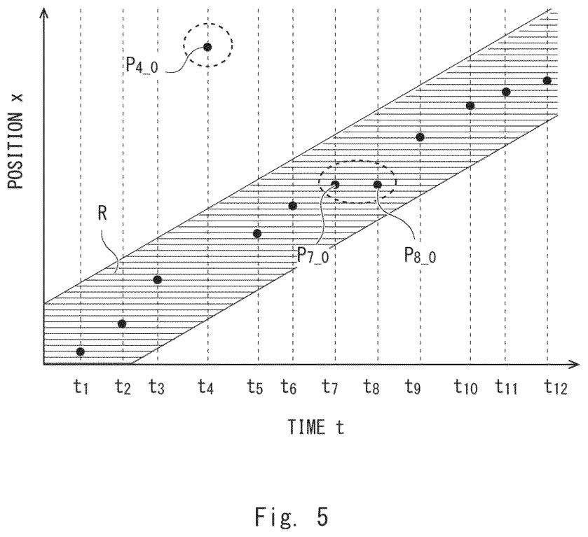

FIG. 5 is a view for explaining abnormal data detection processing according to the second example embodiment. In FIG. 5, a vertical axis denotes a position x, and a horizontal axis denotes a time t. Black plots indicate positioning points. Note that for the sake of explanation, the positions are expressed one-dimensionally.

Here, a constraint range R in FIG. 5 denotes a range in which a position constraint condition defined in the movement constraint condition table Tis satisfied. The abnormality detection unit 121 determines whether each positioning point is within the constraint range R or not. Then, the abnormality detection unit 121 specifies a point P_{4_0} that is outside the constraint range R, and determines this as abnormal data.

In addition, the abnormality detection unit 121 specifies point P_{7_0} and point _{8_0} that are adjacent positioning points whose positions match, and determines the point _{8_0} as abnormal data. In such a case, there is a high possibility that data at time t₈ data are missing. Note that the term “match” may refer not only to a perfect match, but also to a difference between the two being less than a predetermined value.

Note that in a case where a position of a vehicle does not change for a predetermined time or in a case where the vehicle has been gradually decelerating before that time, it is highly likely that data are not missing, but that the vehicle actually stops. The predetermined time is, for example, 30 seconds or 1 minute. Therefore, the abnormality detection unit 121 checks positions of positioning points for a predetermined time, which include the point P_{7_0} and the point _{8_0}. In a case where the positioning points all match, the abnormality detection unit 121 may determine that the vehicle actually stops and the point _{8_0} does not need to be contained in the abnormal data. Further, the abnormality detection unit 121 calculates a speed of each of the positioning points for a predetermined time. In a case where the deceleration is not so sudden that the vehicle cannot perform, the abnormality detection unit 121 does not need to contain the point _{8_0} in the abnormal data.

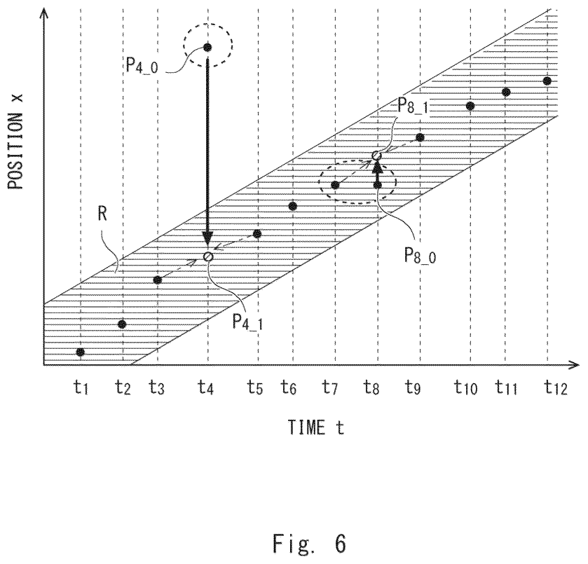

FIG. 6 is a view for explaining first data generation processing according to the second example embodiment. In the present example embodiment, the first generation unit 122 respectively replaces the positions of the abnormal data with positions obtained by assuming uniform motion. For example, with respect to the point P_{4_0} detected as the abnormal data, the first generation unit 122 calculates a position at a time t₄, which is obtained by assuming uniform motion based on the positions of the surrounding positioning points. Specifically, the first generation unit 122 may calculate a speed at a time t₃ or time t₅ with respect to the point P_{4_0}, and correct the position so that the speed at the time t₄ is equal to the speed at the time t₃ or time t₅. Alternatively, the first generation unit 122 may calculate the speed at the time t₃ and time t₅ with respect to the point P_{4_0}, and correct the position so that the speed at the time t₄ becomes the average of the speeds at the time t₃ and time t₅. Thus, the first generation unit 122 replaces the point P_{4_0} with a point P_{4_1}.

In addition, with respect to a point P_{8_0}, the first generation unit 122 also corrects a position at a time t₈ in the similar manner to that for the point P_{4_0}. Thus, the first generation unit 122 replaces the point P_{8_0} with a point P_{8_1}.

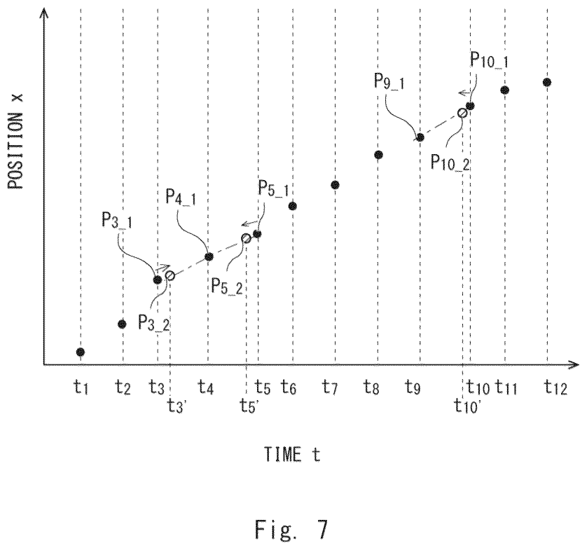

FIG. 7 is a view for explaining second data generation processing according to the second example embodiment. As described above, the GPS data are data that are strictly sampled at irregular cycles. Therefore, as illustrated in FIG. 7, since there is variation in intervals between positioning times, data are shaped so as to become uniform.

The second generation unit 123 performs numerical interpolation on the position of the first data, and samples the numerically interpolated data at a sampling period T1 defined in advance. The sampling period T1 is also referred to as a first cycle. In the present example embodiment, the sampling period T1 is the same as a sampling period set in the GPS receiver (for example, 1 fps).

A value of a position x of the second data generated by the second generation unit 123 is calculated by using linear interpolation from the value of the position x of the first data generated by the first generation unit 122. Such resampling allows fluctuation in the sampling periods to be corrected. Thus, the obtained second data become data close to data sampled at a fixed cycle.

Note that the linear interpolation has been mentioned as a method of numerical interpolation, but Lagrange interpolation, spline interpolation, or other numerical interpolation may be used instead of this.

Further, the sampling period T1 is not limited to the above example, and may take various values. However, it is preferable that the sampling period T1 has a length sufficient to ensure the effect of filtering by a state estimation filter, which will be described later.

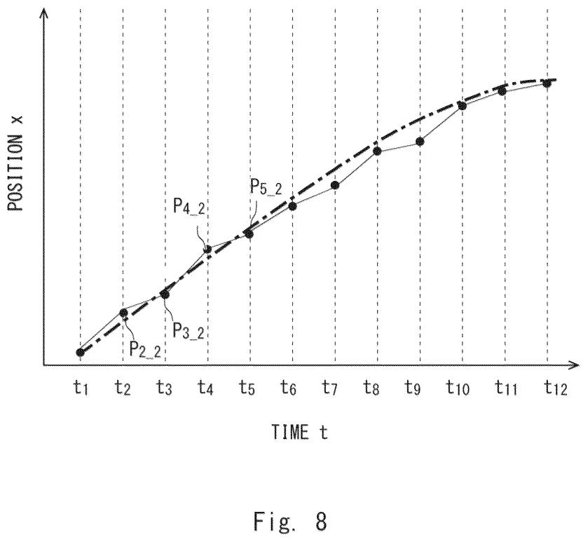

FIG. 8 is a view for explaining third data generation processing according to the second example embodiment. Since the GPS data contain position measurement errors, positional deviation also occurs in the second data. Therefore, the third generation unit 124 filters the second data using a Kalman filter as an example of the state estimation filter. Since the Kalman filter has a characteristic of smoothing zigzag data, third data can be obtained by smoothing the second data by means of filtering.

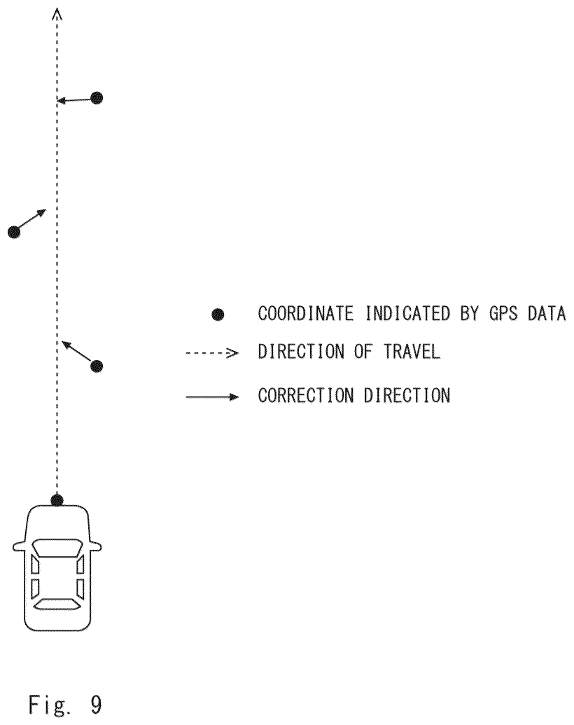

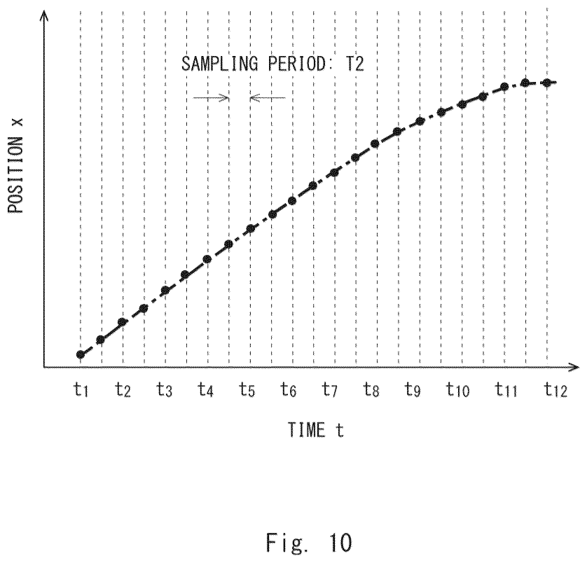

FIG. 9 is a conceptual diagram of smoothing by a Kalman filter according to the second example embodiment. Plots of FIG. 10 are coordinates indicated by GPS data. As illustrated in FIG. 10, even though a vehicle is going straight, there may be a deviation in the coordinates indicated by the GPS data. The smoothing by the Kalman filter means that coordinates deviating from a direction of travel of the vehicle are corrected to the direction of travel. Since an actual position of the GPS data is expressed in two-dimensional coordinates including longitude and latitude, a correction direction thereof may be expressed in two dimensions.

Such smoothing allows the behavior of the vehicle to be grasped more accurately. For example, the smoothing makes it easier to determine whether the following vehicle is going straight, turning right, or turning left.

FIG. 10 is a view for explaining fourth data generation processing according to the second example embodiment. The fourth generation unit 125 generates fourth data by sampling the third data at the same sampling period T2 as the frame rate of the image data. The sampling period T2 is also referred to as a second cycle. The sampling period T2 may be a cycle shorter than the sampling period T1. A method of numerical interpolation is linear interpolation, but may be Lagrange interpolation, spline interpolation, or other numerical interpolation instead of this.

Such resampling can provide position data that can be matched with the information based on the image data.

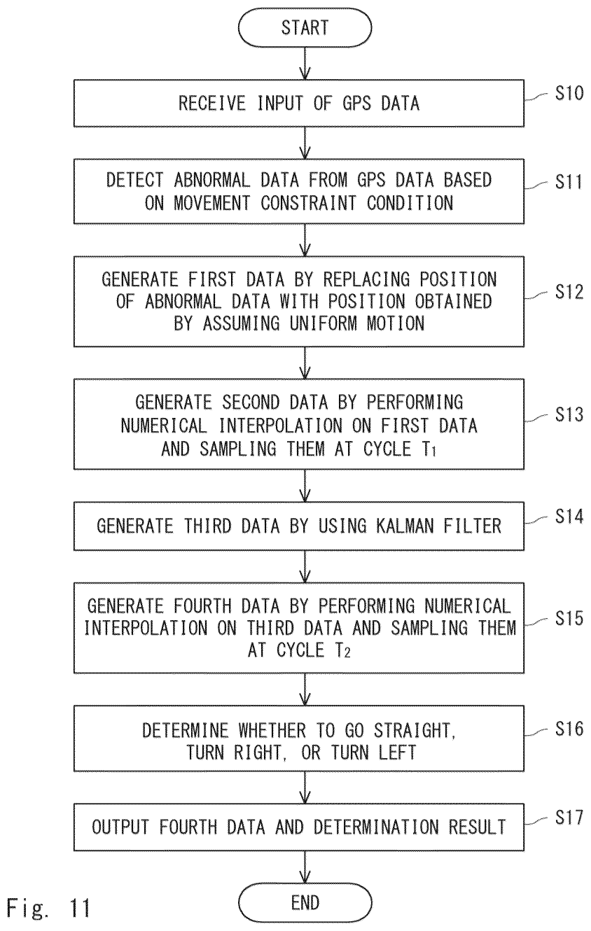

FIG. 11 is a flowchart illustrating an example of a flow of a data shaping method according to the second example embodiment. The input unit 110 first receives an input of GPS data received from the in-vehicle communication apparatus 3 (S10). Subsequently, the abnormality detection unit 11 reads out a movement constraint condition contained in the movement constraint condition table T from the storage unit 130, and detects abnormal data from the GPS data based on the movement constraint condition (S11). Subsequently, the first generation unit 122 replaces a position of the abnormal data with a position obtained by assuming uniform motion (S12). Thus, the first generation unit 122 generates first data. Subsequently, the second generation unit 123 performs numerical interpolation on a position of the first data, and samples the numerically interpolated data at a sampling period T1 (S13). Thus, the second generation unit 123 generates second data. Subsequently, the third generation unit 124 generates third data from the second data by using a Kalman filter (S14). Subsequently, the fourth generation unit 125 performs numerical interpolation on the third data, and samples the numerically interpolated data at a sampling period T2 (S15). Thus, the fourth generation unit 125 generates fourth data. Then, the determination unit 126 determines whether to go straight, turn right, or turn left based on the fourth data (S16). The output unit 140 outputs the fourth data and a determination result (S17).

In a case where an output destination thereof is the image analysis apparatus 30, the image analysis apparatus 30 may then detect an event such as traffic light ignoring or a stop sign based on at least one of the fourth data or the determination result and an analysis result of image data. The above image data are image data photographed at the same time as a positioning time indicated by the fourth data or the determination result. Note that the “same time” may include an error to the extent that the effect is not impaired.

Thus, according to the second example embodiment, the data shaping apparatus 10a appropriately corrects the GPS data missing, the sudden abnormal value, fluctuations in the sampling periods, and the measurement error. Thus, it is possible to improve the accuracy of estimation of the position based on the GPS data suitably. Therefore, it is possible to grasp the behavior of the vehicle more accurately.

The input data required for the processing by the data shaping apparatus 10a are the position, such as longitude and latitude, contained in the GPS data and the positioning time. Since no map data are not required for correction, the correction can be performed easily. Further, there are various formats for saving GPS data, positions such as longitude and latitude and positioning times are contained in GPS data regardless of the saving format. Therefore, the data shaping apparatus 10a can be used universally without depending upon the format of the GPS data.

In addition, the data shaping apparatus 10a resamples data in accordance with the frame rate of the image data. Thus, it is possible to grasp the behavior of the vehicle in more detail by matching the image data with the position data based on the GPS data. Therefore, it can be used in the event detection system 2 that assumes ideal GPS data input.

Note that the present disclosure is not limited to the example embodiments described above, and they may be modified as appropriate without departing from the scope and spirit of the present disclosure.

For example, in the first and second example embodiments described above, it has been described that the abnormality detection unit 121 detects the abnormal data based on the movement constraint condition for the vehicle. However, the abnormality detection unit 121 may detect the abnormal data based on an error detection code associated with the positioning data (the GPS data) instead of or in addition to the movement constraint condition. A checksum can be cited as the error detection code. For example, in a case where the number of reception results each including a checksum, which indicates successful reception, among reception results from satellites is less than a predetermined threshold value, the abnormality detection unit 121 may detect GPS data based on the reception results as abnormal data.

Further, in the second example embodiment described above, it has been described that the linear interpolation is cited as a process of interpolating a position. However, the data shaping apparatus 10a may interpolate the position based on image analysis. For example, since it is possible to extract the amount of background movement by the image analysis and calculate a ratio of speed fluctuation, the data shaping apparatus 10a may interpolate the position in accordance with a calculation result.

Further, in the second example embodiment described above, it has been described that the fourth generation unit 125 matches the sampling period T2 with the frame rate of the image data in order to match the GPS data with the image analysis result. However, the interval of data required for processing differs depending upon the application. For example, the frame rate of the image data changes depending upon codec settings. In addition, in the image analysis processing stage, image analysis may be performed by thinning out frames. Therefore, the sampling period T2 may be different depending upon the application.

Moreover, the sampling by the fourth generation unit 125 can be omitted depending upon the application.

Further, in the second example embodiment described above, it has been described that the output unit 140 outputs both the fourth data and the determination result, but may output any one of them. In addition, the output unit 140 may output at least any of the first data, the second data, or the third data.

Further, in the second example embodiment described above, it has been described that the determination unit 126 determines whether to go straight, turn right, or turn left based on the fourth data. However, the information on which the determination is based may be other information so long as it is information based on the first data. For example, the determination unit 126 may determine whether to go straight, turn right, or turn left based on the first data, the second data, or the third data.

Any arbitrary process of the present disclosure can also be realized by causing a processor to execute computer programs.

In the examples described above, the program includes instructions (or software codes) that, when loaded into a computer, cause the computer to perform one or more of the functions described in the example embodiments. The program may be stored in a non-transitory computer-readable medium or a tangible storage medium. By way of example, and not limitation, computer-readable media or tangible storage media include a random-access memory (RAM), a read-only memory (ROM), a flash memory, a solid-state drive (SSD) or other memory techniques, a CD-ROM, a digital versatile disc (DVD), a Blu-ray (registered trademark) disk or other optical disk storage, a magnetic cassette, a magnetic tape, a magnetic disk storage, or other magnetic storage devices. The program may be transmitted on a transitory computer readable medium or a communication medium. By way of example, and not limitation, transitory computer-readable media or communication media include electrical, optical, acoustic, or other forms of propagated signals.

Some or all of the example embodiments described above may be described as the following supplementary notes, but are not limited thereto.

### (Supplementary Note 1)

A data shaping apparatus comprising:
abnormality detection means for detecting, as abnormal data, positioning data indicating an abnormal position from a positioning data group based on a movement constraint condition for a moving object, the positioning data group being a collection of positioning data at least indicating a position and a positioning time of the moving object;
first generation means for generating first data from the positioning data group by replacing a position indicated by the abnormal data with a position assumed under a predetermined movement condition; and
output means for outputting information based on the first data.

### (Supplementary Note 2)

The data shaping apparatus according to supplementary note 1, wherein
the abnormality detection means detects, as the abnormal data, positioning data in which a difference in position between positioning data measured at adjacent times or a difference in speed between positioning data measured at adjacent times is equal to or greater than a predetermined threshold value or more.

### (Supplementary Note 3)

The data shaping apparatus according to supplementary note 1 or 2, wherein
the abnormality detection means detects the abnormal data further based on an error detection code associated with the positioning data.

### (Supplementary Note 4)

The data shaping apparatus according to any one of supplementary notes 1 to 3, further comprising:
second generation means for generating second data by sampling data obtained by numerically interpolating the first data at a first cycle defined in advance.

### (Supplementary Note 5)

The data shaping apparatus according to supplementary note 4, further comprising:
third generation means for generating third data by smoothing the second data using a state estimation filter.

### (Supplementary Note 6)

The data shaping apparatus according to supplementary note 5, further comprising:
fourth generation means for generating fourth data by sampling data obtained by numerically interpolating the third data at a second cycle shorter than the first cycle,
wherein the output means outputs the fourth data as the information based on the first data.

### (Supplementary Note 7)

The data shaping apparatus according to any one of supplementary notes 1 to 6, further comprising:
determination means for determining whether the moving object is going straight, turning right, or turning left based on the information based on the first data.

### (Supplementary Note 8)

An event detection system comprising:
a data shaping apparatus including:
   abnormality detection means for detecting, as abnormal data, positioning data indicating an abnormal position from a positioning data group based on a movement constraint condition for a moving object, the positioning data group being a collection of positioning data at least indicating a position and a positioning time of the moving object;
   first generation means for generating first data from the positioning data group by replacing a position indicated by the abnormal data with a position assumed under a predetermined movement condition; and
   output means for outputting information based on the first data; and
an image analysis apparatus configured to detect an event related to a vehicle on a basis of the information based on the first data and an image analysis result.

### (Supplementary Note 9)

The event detection system according to supplementary note 8, wherein
the image analysis apparatus detects the event on the basis of the information based on the first data and an analysis result of image data photographed at a same time as the positioning time indicated by the information.

### (Supplementary Note 10)

A data shaping method comprising:
detecting, as abnormal data, positioning data indicating an abnormal position from a positioning data group based on a movement constraint condition for a moving object, the positioning data group being a collection of positioning data at least indicating a position and a positioning time of the moving object;
generating first data from the positioning data group by replacing a position indicated by the abnormal data with a position assumed under a predetermined movement condition; and
outputting information based on the first data.

### (Supplementary Note 11)

A non-transitory computer-readable medium storing a program causing a computer to execute:
an abnormality detection process of detecting, as abnormal data, positioning data indicating an abnormal position from a positioning data group based on a movement constraint condition for a moving object, the positioning data group being a collection of positioning data at least indicating a position and a positioning time of the moving object;
a first generation process of generating first data from the positioning data group by replacing a position indicated by the abnormal data with a position assumed under a predetermined movement condition; and
an output process of outputting information based on the first data.

### REFERENCE SIGNS LIST

1 SYSTEM
2 EVENT DETECTION SYSTEM
3 IN-VEHICLE COMMUNICATION APPARATUS
4 GPS RECEIVER
5 IN-VEHICLE CAMERA
10, 10a DATA SHAPING APPARATUS
11 ABNORMALITY DETECTION UNIT
12 FIRST GENERATION UNIT
14 OUTPUT UNIT
20 PREPROCESSING APPARATUS
30 IMAGE ANALYSIS APPARATUS
110 INPUT UNIT
120 CONTROL UNIT
121 ABNORMALITY DETECTION UNIT
122 FIRST GENERATION UNIT
123 SECOND GENERATION UNIT
124 THIRD GENERATION UNIT
125 FOURTH GENERATION UNIT
126 DETERMINATION UNIT
130 STORAGE UNIT
140 OUTPUT UNIT
N NETWORK
T MOVEMENT CONSTRAINT CONDITION TABLE
R CONSTRAINT RANGE
P POINT

What is claimed is:

1. A data shaping apparatus comprising:
at least one memory storing instructions; and
at least one processor configured to execute the instructions to:
detect, as abnormal data, positioning data indicating an abnormal position from a positioning data group based on a movement constraint condition for a moving object, the positioning data group being a collection of positioning data at least indicating a position and a positioning time of the moving object;
generate first data from the positioning data group by replacing a position indicated by the abnormal data with a position assumed under a predetermined movement condition; and
output information based on the first data.

2. The data shaping apparatus according to claim 1, wherein
the at least one processor is configured to execute the instructions to detect, as the abnormal data, positioning data in which a difference in position between positioning data measured at adjacent times or a difference in speed between positioning data measured at adjacent times is equal to or greater than a predetermined threshold value or more.

3. The data shaping apparatus according to claim 1, wherein
the at least one processor is configured to execute the instructions to detect the abnormal data further based on an error detection code associated with the positioning data.

4. The data shaping apparatus according to claim 1, wherein
the at least one processor is configured to execute the instructions to generate second data by sampling data obtained by numerically interpolating the first data at a first cycle defined in advance.

5. The data shaping apparatus according to claim 4, wherein
the at least one processor is configured to execute the instructions to generate third data by smoothing the second data using a state estimation filter.

6. The data shaping apparatus according to claim 5, wherein
the at least one processor is configured to execute the instructions to generate fourth data by sampling data obtained by numerically interpolating the third data at a second cycle shorter than the first cycle, and
the output means outputs the fourth data as the information based on the first data.

7. The data shaping apparatus according to claim 1, wherein
the at least one processor is configured to execute the instructions to determine whether the moving object is going straight, turning right, or turning left based on the information based on the first data.

8. An event detection system comprising:
a data shaping apparatus including:
at least one memory storing instructions; and
at least one processor configured to execute the instructions to:
detect, as abnormal data, positioning data indicating an abnormal position from a positioning data group based on a movement constraint condition for a moving object, the positioning data group being a collection of positioning data at least indicating a position and a positioning time of the moving object;
generate first data from the positioning data group by replacing a position indicated by the abnormal data with a position assumed under a predetermined movement condition; and
output information based on the first data; and
an image analysis apparatus configured to detect an event related to a vehicle on a basis of the information based on the first data and an image analysis result.

9. The event detection system according to claim 8, wherein
the image analysis apparatus detects the event on the basis of the information based on the first data and an analysis result of image data photographed at a same time as the positioning time indicated by the information.

10. A data shaping method comprising:
detecting, as abnormal data, positioning data indicating an abnormal position from a positioning data group based on a movement constraint condition for a moving object, the positioning data group being a collection of positioning data at least indicating a position and a positioning time of the moving object;
generating first data from the positioning data group by replacing a position indicated by the abnormal data with a position assumed under a predetermined movement condition; and
outputting information based on the first data.

11. (canceled)
